(19) United States
(12) Patent Application Publication
(10) Pub. No.: US 2025/0169461 A1
(43) Pub. Date: May 29, 2025

(54) Pretty Kitty Litter Mat

(71) Applicant: Cornelia Egondu Ojimba, Martinez, GA (US)

(72) Inventor: Cornelia Egondu Ojimba, Martinez, GA (US)

(21) Appl. No.: 18/523,181

(22) Filed: Nov. 29, 2023

(51) Int. Cl. A01K 1/01

(52) U.S. Cl. CPC A01K 1/0114

(57) ABSTRACT

A large piece of sponge, but of much greater length and width than depth, e.g. 20″ by 14″ by 2″.

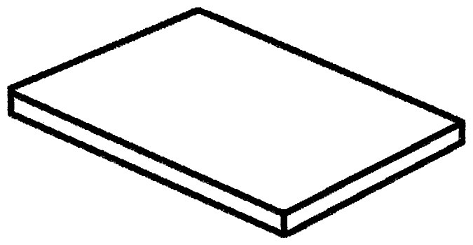

FIG. 1: drawing of the litter mat (not exactly to scale).

Description: a large piece of sponge, but of much greater length and width than depth, e.g. 20″ by 14″ by 2″ (FIG. 1).

Manner and process of making: the same as for a typical bath sponge, adjusting for the dimensions.

Manner of using: as with any cat litter mat, place next to exit from litter box. As a cat leaves the litter box, it makes a few steps on the litter mat, so any litter still sticking to the cat's feet gets captured by the mat. The mat can be periodically cleaned by either shaking out the captured litter (e.g., back into the litter box), or using a vacuum cleaner. The mat can also be hand- or machine-washed, then air- or machine-dried.

Best mode of carrying out: as above.

1. The invention consists of the new and nonobvious use of a large, flat piece of sponge as a cat litter mat (per MPEP 2112.02.II).
A cat litter mat comprising a large, flat piece of sponge.
The invention consists of the new and nonobvious use of a large, flat piece of sponge, e.g. 20″ by 14″ by 2″, as a cat litter mat (per MPEP 2112.02.II).
(A cat litter mat is a mat placed next to a cat litter box, intended to capture as much as possible of any litter sticking to a cat's paws as it exits the litter box.)
